(19) United States
(12) Patent Application Publication
(10) Pub. No.: US 2004/0090961 A1
(43) Pub. Date: May 13, 2004

(54) Parallel processing routing device

(75) Inventor: Albert Lespagnol, St Cyr I'Ecole (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/418,093

(22) Filed: Apr. 18, 2003

(30) Foreign Application Priority Data
Apr. 19, 2002 (FR) 02 04 931

(51) Int. Cl. H04L 12/28; H04L 12/56

(52) U.S. Cl. 370/392

(57) ABSTRACT

A data routing device comprises, firstly, a management module (9) having a buffer memory (10) divided into m sub-memories storing primary routing data and a storage address (FSA(n))at selected addresses in the form of data packet segment portions, which sub-memories are associated with secondary data to be routed and adapted to deliver some of the portions that they store on command at m first parallel outputs, and, secondly, a transfer module (12) adapted i) to receive selected storage addresses of segment portions from the management module (9), ii) to deliver said storage addresses to the management module as a function of a selected criterion so as to receive in return at the first parallel outputs the segment portions stored at said storage addresses, and iii) to direct the portions belonging to different segments to at least two routing tables so as to determine in parallel, portion by portion, from data stored in said routing tables and from an analysis of the various segments, tertiary data to designating output ports (7) and new primary routing data to be associated with secondary data, stored at the storage address (FSA(n)), and to be routed to the output ports (7) designated by the tertiary data.

The invention relates to the field of handling data packets in a network and more particularly to devices providing at least a routing function.

In the present context, the term “routing” refers to the function of transferring data packets in a network at level 3 of the ISO model.

Routing is a function essential to the transmission of data in networks. It consists of using a routing table to determine at each node of a network the next node enabling optimum transmission of a data packet between its source and its destination. It is effected either by level 3 forwarding (L3F) routers or by “composite” data packet handling devices known as switch-routers effecting switching and routing at the same time.

Because of the permanent evolution of networks, especially public networks, it is essential to refresh the routing tables frequently, typically every five seconds. This necessitates exchanging large volumes of data, typically several megabits, which significantly limits the performance of the routing or switching device. Moreover, the distributed architecture of existing routing or switching devices is proving less and less suitable for ever increasing network traffic.

Thus an object of the invention is to remedy some or all of the above-mentioned drawbacks.

To this end it proposes a data routing device comprising i) a management module adapted to receive primary routing data and a storage address of secondary data associated with the primary data and ii) a transfer module adapted to determine from the data and from data stored in at least one routing table tertiary data designating at least one output port of a data transport stage and new primary routing data and to deliver the primary and tertiary data so determined to the transport stage so that at least some of the new primary data is combined with the secondary data stored at the storage address and then sent to each output port designated by the tertiary data.

The expression “data transport stage” refers to a stage including an input sub-stage (also known as an “ingress stage”) with input ports for receiving the data packets, a buffer memory for temporarily storing the data to be routed at a storage address, and an output sub-stage (also known as an “egress stage”) with output ports for sending the routed data.

The above device is characterized in that:

its management module includes a buffer memory divided into n sub-memories each adapted to store at a selected address a portion of each segment resulting from decomposition of data packets received and to deliver one of the portions that they store simultaneously on demand at n first parallel outputs,

the transfer module is adapted, firstly, to receive from the management module the selected storage addresses of the first segments of the packets to be routed, secondly, to deliver the storage addresses of some of the these first segments to the management module as a function of a selected criterion in order to receive in return at the first parallel outputs the segment portions stored at the storage addresses, and, thirdly, to direct the portions belonging to different segments to one or more routing table so as to determine the primary and tertiary data associated with the secondary data from data stored in the routing tables and a portion by portion analysis of the various segments.

The new architecture means that the number of parallel routing tables can be chosen as a function of the bit rate of the data to be routed. Moreover, the novel design of the device of the invention means that it can be installed in new types of switch-router with a centralized architecture and in which traffic control and buffering in particular can be shared.

The data preferably reaches the management module directly in the form of segments of equal length that no longer have to be divided into portions. The segmentation is effected by the data transport stage of a packet handling device, for example.

The management and transfer modules advantageously constitute an L3F routing stage that can be coupled to a data transport stage.

In a preferred embodiment, the transfer module includes an input stage provided with, firstly, n registers adapted to store the storage addresses of n first segments, secondly, an input buffer memory adapted to receive the selected addresses of the first segments from the management module to feed the registers, and, thirdly, a packet handling unit (or shifter) having n inputs respectively fed with n segment portions by the n first parallel outputs and at least one second output adapted to deliver the directed portions belonging to different segments. Each handling unit preferably has the same number of inputs as second outputs.

Also in a preferred embodiment, the transfer module includes from 1 to n (this number depends on the number of packets to be routed per second) routing units fed with different segment portions by the second outputs and each including a rewritable memory storing one of the routing tables and adapted to determine in parallel the primary and tertiary data associated with the secondary data. The transfer module preferably has the same number of parallel routing units as second outputs.

According to another feature of the invention, each routing table constitutes what is known to the person skilled in the art as a “trie” table. It therefore stocks in rows primary data that defines words representative of routing prefixes, and each received segment portion is used to address one of the words in a row. Each routing table (i.e. each trie table) preferably stores primary data representative of words of first and second types, the first and second types respectively defining “intermediate” words and “final” words, only the final words representing new primary routing data.

It is advantageous if the transfer module includes an output stage with the same number of output buffer memories as there are output ports of the transport stage and adapted to receive the tertiary data, the new primary data, and the storage address of the routing units. A group of output buffer memories can instead be provided for each output port, for example to offer more than one quality of service. In this case it is advantageous if the output stage also includes a multiplexer fed by the routing units and feeding the output buffer memories.

If the routing units include routing tables of the “trie table” type, each can preferably, firstly, include an intermediate module including an output coupled to the rewritable memory (storing the trie table) and first and second inputs respectively fed by one of the second outputs of the input stage and by the output of the rewritable memory and, secondly, be adapted to extract from the routing table the word stored at the address designated by the received portion and then to deliver the word to the output of the rewritable memory so that it feeds the second input of the intermediate module or the output stage, according to whether the word extracted is of the first or of the second type. In this case, the intermediate module is adapted, on receiving data representative of a word of the first type, to extract from the routing table the word stored at the address designated by the word of the first type and then to deliver the word to the output of the rewritable memory so that it feeds the second input of the intermediate module or the output stage, according to whether the extracted word is of the first type or of the second type. This operation is repeated until a final word (of the second type) is extracted from the routing table concerned.

In a preferred embodiment, the input and output buffer memories are first in first out (FIFO) memories.

The invention also proposes a router or a packet handling device (of the switch-router type) equipped with a data transport stage and a device of the invention. In this case, the device of the invention constitutes the routing stage of the router or the switch-router, which is coupled to the data transport stage.

The present invention also proposes a method of routing secondary data associated with primary routing data and a storage address, in which method tertiary data designating at least one output port and new primary routing data is determined from the primary data and from data stored in at least one routing table, after which the primary and tertiary data so determined is delivered so that at least some of the new primary data is combined with the secondary data stored at the storage address and then sent to each output port designated by the tertiary data.

The method is characterized in that the tertiary data designating at least one output port and new primary routing data is determined by, firstly, storing in n sub-memories, at selected addresses, n portions of each segment resulting from subdivison of the data received and to be routed, including first segments, secondly, storing at selected locations the selected storage addresses of successively received first segments and then, as a function of a selected criterion, extracting from the sub-memories, in parallel, the portions stored at the storage addresses contained in some of the selected locations so as to deliver the segment portions simultaneously and in parallel, and, thirdly, directing the portions belonging to different segments to at least one routing table (as required) so as to determine the primary and tertiary data to be associated with the secondary data to be routed from data stored in the routing tables and a portion by portion analysis of the various segments.

The routing data is preferably received in the form of segments of equal length.

The routing is preferably L3F routing.

The storage addresses of the portions of the same segment are preferably stored in n substantially identical registers.

The number of routing tables is preferably the same as the number of sub-memories.

According to another feature of the method of the invention, each routing table (trie table) stores primary data defining words representative of routing prefixes in the form of rows and each received segment portion is used to address one of the words of a row. The primary data is preferably representative of words of first and second types. In this case, during the determination phase, the word stored at the address designated by the received segment portion is extracted from the routing table and is then delivered so that it feeds the routing table again or the output ports, according to whether the extracted word is of the first type or of the second type, and each time that a word of the first type is delivered another word stored at the address designated by the word delivered is extracted from the table, and so on until a word of the second type is obtained.

The devices and the method of the invention described hereinabove are particularly, although not exclusively, suitable for routing standards such as the Internet Protocol (IP), regardless of the media, and those corresponding to connectionless protocols.

Other features and advantages of the invention become apparent on examining the following detailed description and the appended drawings, in which:

FIG. 1 is a block diagram showing a routing device of the invention constituting a router,

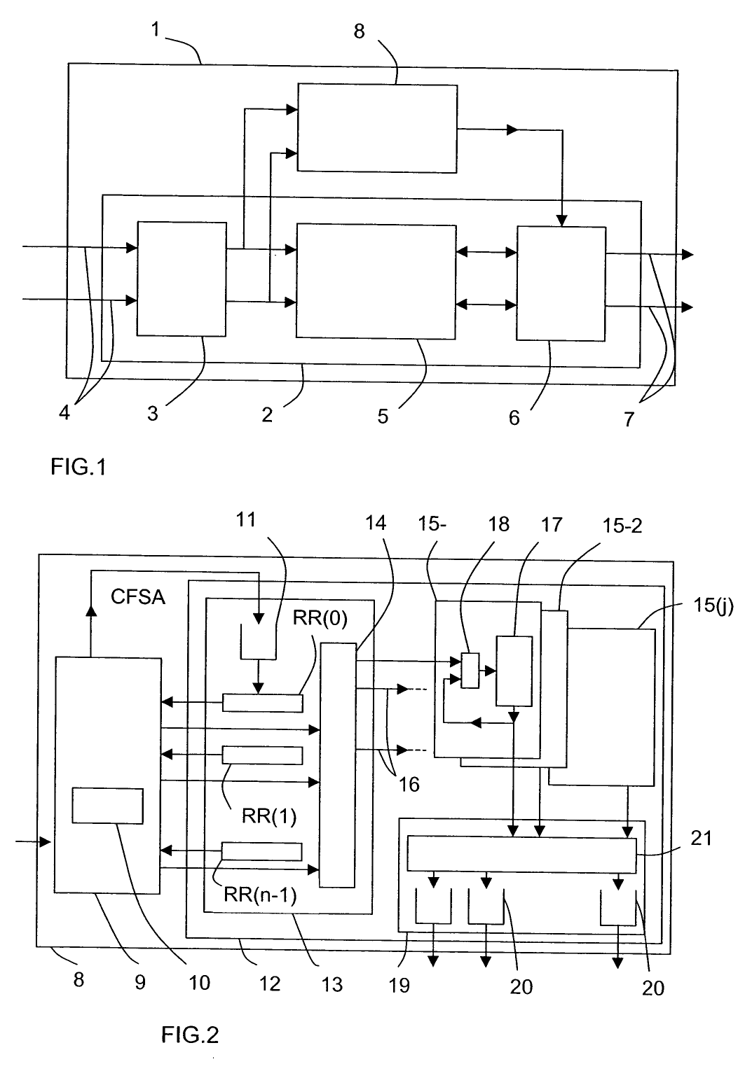

FIG. 2 is a block diagram showing a routing stage of the FIG. 1 device,

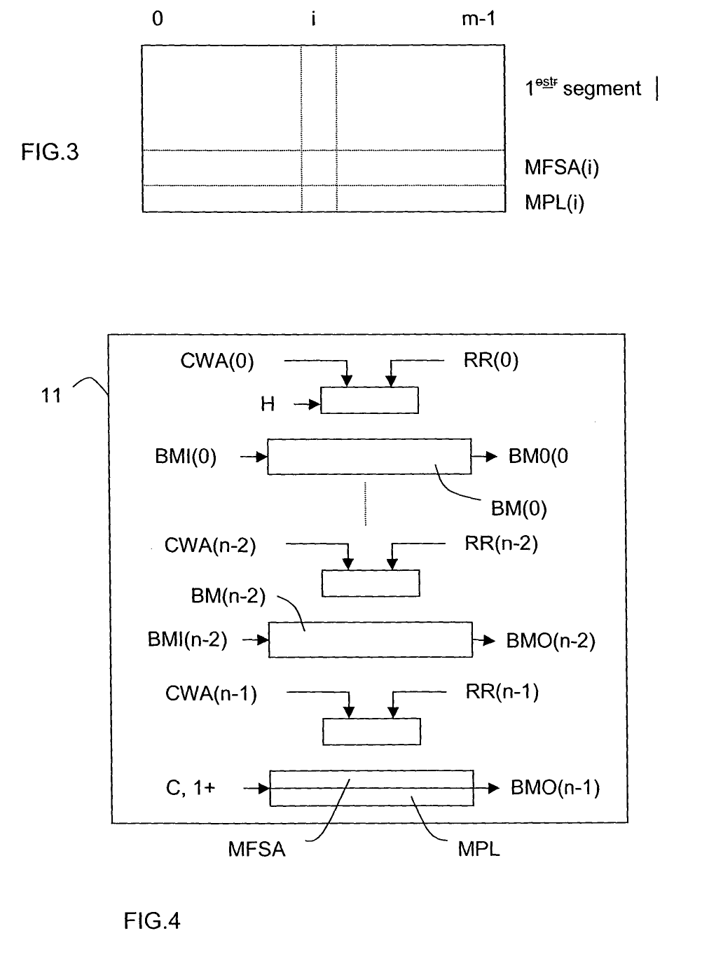

FIG. 3 is a diagram showing one example of the organization of a buffer memory of a management module of the FIG. 2 routing stage,

FIG. 4 is a diagram showing one example of the implementation of a buffer memory of a management module of the FIG. 2 routing stage,

FIG. 5 is a diagram showing one mode of storing (writing) data in the buffer memory of the management module of the FIG. 2 routing stage,

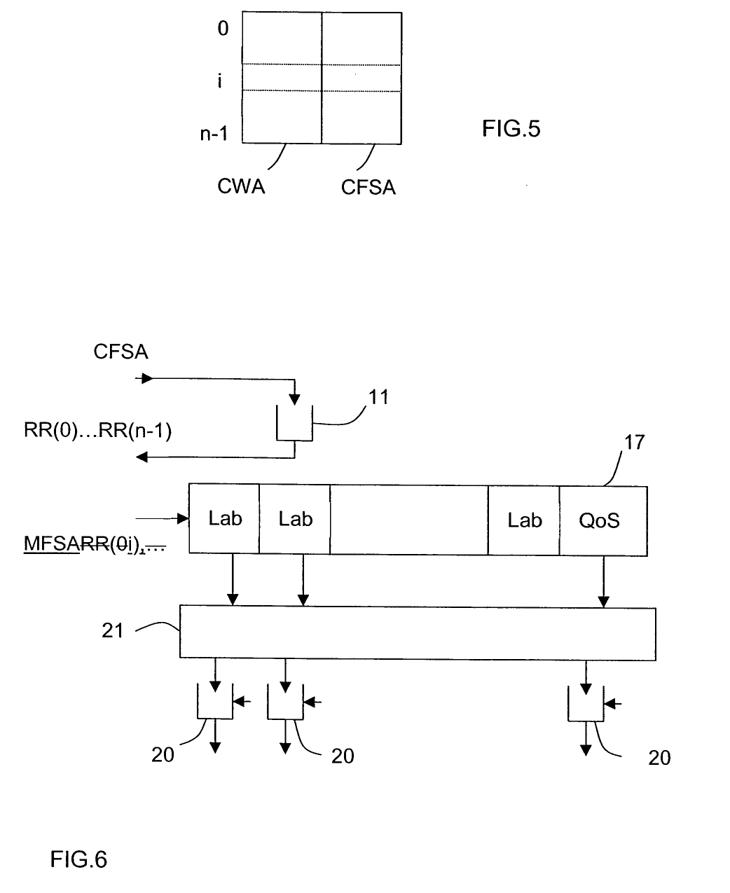

FIG. 6 is a diagram showing one example of a routing mechanism,

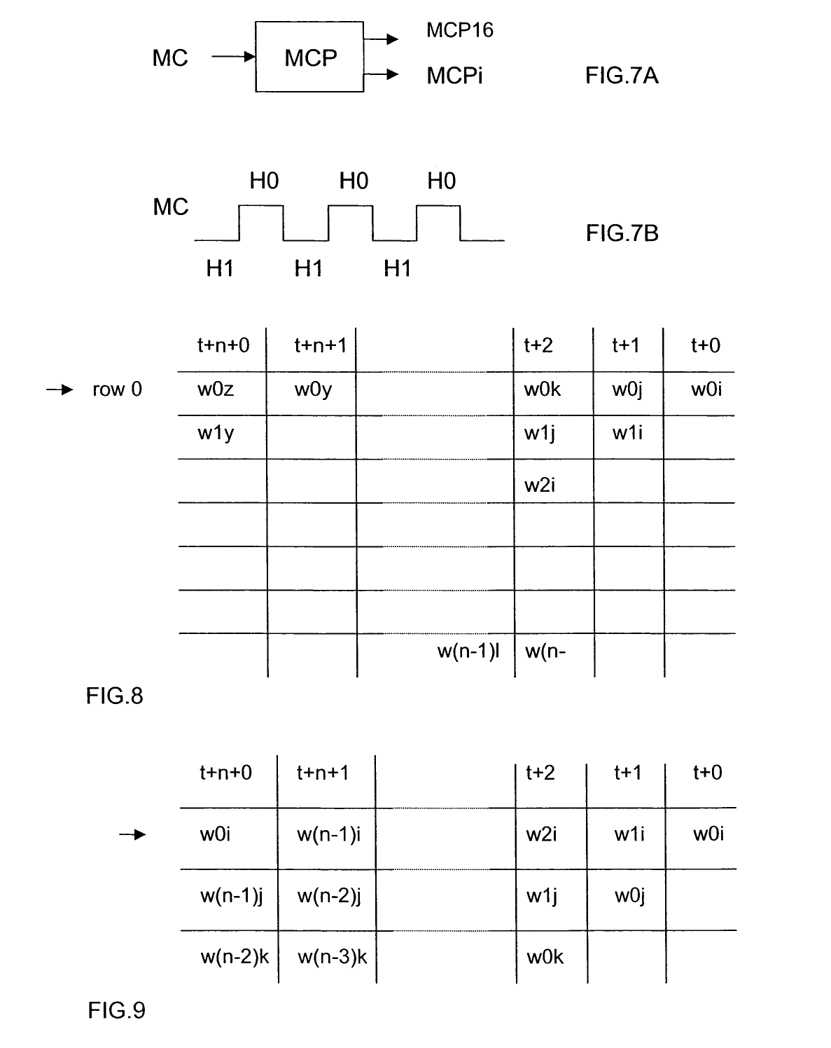

FIGS. 7A and 7B are diagrams showing signals generated by a main clock of the device and the connection between the main clock and the counters of the device,

FIG. 8 is a table illustrating one mode of reading data at the input of the packet handling module of the transfer module of the routing stage,

FIG. 9 is a table illustrating one mode of reading data at the output of the packet handling module of the transfer module of the routing stage, and

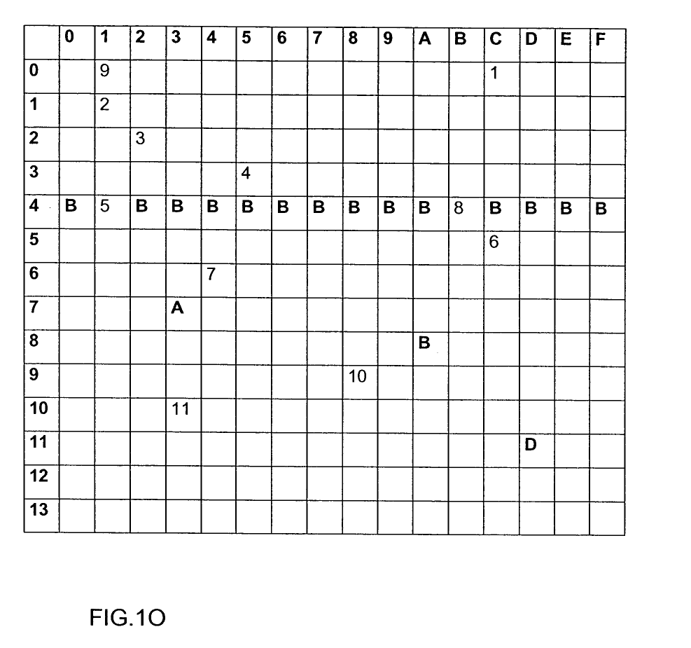

FIG. 10 is an example of “trie table” type routing table.

The drawing is for the most part of a specific nature and consequently constitutes part of the description of the invention as well as contributing to the definition of the invention.

Reference is made initially to FIG. 1 for a description of one embodiment of a routing device of the invention constituting a router. of course, the device of the invention could instead be installed in a packet handling device of the switch-router type, in particular one with centralized switching and routing functions, or it could constitute only the routing stage of a router.

The device 1 firstly comprises a data transport stage 2 comprising an input sub-stage (also known as an “ingress stage”) 3 with input ports 4 for receiving data packets, a buffer memory 5 for temporarily storing data to be handled communicated by the input sub-stage 3, and an output sub-stage (also known as an “egress stage”) 6 with output ports 7 for delivering handled data, in particular from the buffer memory 5.

The device 1 further includes a routing stage 8 fed with routing data by the input sub-stage 3 and feeding the output sub-stage 6 with new routing data.

The components of the device 1 are synchronized by a main clock MCL whose period serves as the basis for incrementing a main counter MCP and auxiliary counters (MCP16, MCPi), as shown in FIGS. 7A and 7B. MCPx is a modulo x counter incremented at the timing rate of the clock MCL.

The data transport stage 2 is described in detail in the documents U.S. Pat. No. 5,237,564 and EP 00/440 281, the full technical contents of which are incorporated herein by way of reference. Consequently, only the main functions of the transport stage 2 are described here, and not their auxiliary functions.

The input sub-stage 3 is firstly adapted to receive data packets of varying length at its l input ports 4 and to extract from that data primary data representative of routing information that must be processed by the routing stage 8 and secondary data that is to be routed.

The secondary data is sent to the buffer memory 5 and stored therein at a storage address FSA(s). For example, if the buffer memory 5 can store s segments, then a counter MCPs indicates at all times the storage address FSA(s) for the incoming segment in the buffer memory 5. The primary data is communicated to the routing stage 8, together with the storage address FSA(s) (which is in fact the current value of MCPs) at which the associated secondary data is temporarily stored in the buffer memory 5.

As described in the above-mentioned patent documents, the received data packets are preferably first segmented in the input sub-stage 3 before their data is sent to the buffer memory 5 and to the routing stage 8. Segmentation consists of dividing each packet into segments of equal length, preserving the link that unites them at the level of the buffer memory 5 and the routing stage 8. Once the new routing information has been determined by the routing stage 8, the secondary data of the original packet awaiting transmission in the buffer memory 5 is reconstituted by adding the new routing information (primary data) to it before it is communicated to the output ports 7.

The routing stage 8 counts the number of segments of a received packet (PL(i)) as and when segments arrive.

The primary data is usually contained in the first segment of the received packet. It generally includes the packet source port and address and the packet destination port and address.

In the case of routing, the primary data is generally routing information, for example the destination address, used to index the routing table. The routing information is generally a global identifier, meaning that no connection has to be set up before the packet is sent. Many routing protocols function in accordance with this principle, in particular the Internet Protocol (IP), regardless of the media. In the case of the IP, the global identifier, referred to as the IP address, is used to route the packet locally and the next primary data delivered by the routing table constitutes a new label used for routing in the next device.

If the device 1 has l input ports 4, each segment is divided into l portions (also known as words). The time to process a word (portion) is equal to the period of the main clock MCL. The input ports 4 are adapted so that a segment arriving at the port i is placed one word in front of a segment arriving at the port i-1, modulo l. Similarly, the output ports 7 are adapted so that a segment sent to the port i is placed one word in front of a segment sent to the port i−1, modulo l.

Reference is made below to FIGS. 2 to 10 for a description of one embodiment of a routing stage of the invention.

The routing stage 8 shown in FIG. 2 is of the L3F type. It includes a management module 9 including a management buffer memory 10 in which the primary routing data contained in the first segment sent by the input sub-stage 3, the storage address FSA(s) in the buffer memory 5 of the first segment of the secondary data associated with the primary data, and (preferably) the total number of segments PL(i) of the associated packet are stored at a selected address i.

As shown in FIG. 3, the first segments and the complementary data (MFSA(i) and MPL(i)) are preferably stored vertically in the management buffer memory 10, which is preferably a circulating memory. Consequently, if the buffer memory 10 has m inputs (also known as columns), a first segment is replaced by a new first segment when m packets to be routed have been received.

The size m of the buffer memory 10 can easily be controlled as a function of the bit rate of the packets incoming into the device 1 and the service bit rate of the device 1 (or the bit rate at which the packets are routed). The service bit rate is preferably higher than the input bit rate so that, even with a small size m of the buffer memory 10, it is guaranteed that no segment will be lost (or replaced, which would lead to the loss of the associated packet).

The segments that reach the management module 9 are divided into segment portions each consisting of one word. Consequently, as shown diagrammatically in FIG. 4, the management buffer memory 10 is divided into n identical and independent sub-memories BM(0) to BM(n−1), each sub-memory BM(r) storing a portion (word) M(r) having the rank r in all the segments. Each word (portion) is written into the sub-memories BM(r) via a bus BMI(r) and extracted therefrom via a bus BMO(r).

The main clock MCL synchronizes reading (extraction from) and writing (entry in) of the buffer memory 10. As shown in FIG. 7A, the clock half-period H1 is dedicated to writing and the clock half-period H0 is dedicated to reading. Moreover, as shown in FIG. 3, the sub-memories BM(r) are addressed in read mode and in write mode via a multiplexer.

To be more precise, as shown in FIG. 5, for writing, two counters are associated with each sub-memory BM(r). The counter CWA(r) contains the address of the buffer memory 10 in which an incoming word (portion) of rank r of a segment is to be stored. The counter CFSA(r) contains the address of the buffer memory 10 in which the first segment of a packet is stored. Because the buffer memory 10 includes n sub-memories BM(r), there are n pairs of counters (CWA, CFSA).

The counters preferably take the form of a circular shift buffer, which shifts the stored data by one step in each period of the clock MCL following a write operation. For example, the row “0” takes the value of the row “n−1”, the row “1” takes the value of the row “0”, . . . , the row “n−1” takes the value of the row “n−2”.

Two situations can arise before the shift is effected. If the first segment of a new packet arrives, then, if i represents the value of CFSA(0):

MFSA(i): address of the first segment in the buffer memory 5, given by the value of the main counter MCP(s), where s is the size of the buffer memory 5;

MPL(i)=1;

CFSA(0)=CWA(0); and

CWA(n−1)=CWA(0)+1 (modulo m). This latter operation increments the address at which the next segment received is stored, thereby ensuring that the segment that arrived previously is not overwritten.

This operation is not effected if the current segment is not the first segment of a packet. Consequently, this segment is overwritten by future segments until a new first segment arrives.

If the segment received is not the first segment of a new packet, then, if i represents the value of CFSA(0):

MPL(i)=MPL(i)+1 (modulo m).

When the last segment of a packet is received, the address (CFSA(0)) of the first segment of the packet in the buffer memory 10 is placed in the queue of an input buffer memory 11, which is preferably of the FIFO type, so that the primary data received is processed as a function of its order of arrival in the routing stage 8. Only the address of the first segment is stored in the FIFO input memory 11, because the various portions of the first segment are stored in the same column of the buffer memory 10 (the stored address is therefore that of the column). If the FIFO input memory 11 contains data at the head of its queue, that data is processed just like the secondary data of the associated packet. The size of the FIFO input memory 11 is preferably equal to the size of the management buffer memory 10.

The FIFO input memory 11 is part of a transfer module 12 of the routing stage 8 coupled to the management module 9 (see below).

All the ports of the input sub-stage 3 and the output sub-stage 6 preferably have the same bit rate as the line interface cards coupled to the device 1. However, as described in the patent document EP 00/440 281, line interface cards can be used that have a bit rate equal to an integer multiple of that of the input port 4 and output port 7. For example, if the bit rate of the ports is equal to 2.4 Gbit/s, four ports can be associated with an OC192c format line interface.

To this end, each line interface can be connected to k successive ports [j, j+1, . . . , j+k−1]. The case where k=1 corresponds to a line interface connected to a single port. In this case, if the first word of a segment is received at the port j+x (subject to the condition 0≦x<k), the two situations described above are modified as follows.

If the first segment of a new packet arrives, then, if i represents the value of CFSA(0+x):

MFSA(i): address of this first segment in the buffer memory 5, given by the value of the main counter MCP(s), where s is the size of the buffer memory 5;

MPL(i)=1;

CFSA(0+x)=CWA(0+x); and

CWA(n−1)=CWA(0+x)+1 (modulo m).

If the segment received is not the first segment of a new packet, then, if i represents the value of CFSA(0+x):

MPL(i)=MPL(i)+1 (modulo m).

In this case, of the k pairs of counters (CWA, CFSA) associated with the line interface, only the first pair is used.

As indicated above, the buffer memory 10 of the management module 9 is read during the half-period of the clock MCL reserved for it. As shown in FIG. 6, each time that the whole of a packet has been received by the routing stage, to be more precise by the management module 9, the address CFSA(0) at which the various portions (words) of its first segment are stored in the buffer memory 10 of the management module 9 is placed at the end of the queue of the FIFO input memory 11. During the half-period dedicated to writing in the FIFO input memory 11, the following operations are effected:

RR(i)=RR(i−1);

if the FIFO input memory 11 is not empty, the first value is transferred into RR0; prior to this transfer, each RR(i+1) takes the value RR(i).

The above address values are subsequently communicated to the management module 9 for it to read the single word (portion) stored in each sub-memory BM(r) of its buffer memory 10 at the address designated by the value from the associated register RR(r).

Of course, the address can vary from one sub-memory to another. In principle, in each clock period a different column is read in each sub-memory BM(i) of the buffer memory 10.

The number of registers RR is equal to the maximum number of portions to be analyzed contained in a single segment.

The information (primary data, storage address FSA(n), and total number PL of associated segments) is then communicated, substantially simultaneously, by the management module 9 to the transfer module 12 via n first parallel outputs.

The buffer memory 11 and the registers RR(r) are preferably part of an input stage 13 of the transfer module 12, which further includes a routing module (or barrel shifter) 14 with n inputs respectively fed by the n first outputs of the management module 9.

The handling module 14 receives from the first outputs of the management module 9 the primary data in the form of portions (words w(r)) and the associated complementary data (FSA(n) and PL(i)) in order to direct them to one or more routing units 15 via one or more second outputs 16 at a rate set by the main clock MCL. To be more precise, the handling module 14 receives the successive portions of the segments in parallel and directs them to its second outputs 16, taking care to deliver all the portions of the same segment to the same output 16, so that the segments are analyzed in parallel and portion by portion. The handling module 14 therefore has n different and ordered states and goes from one state to the next state in each period of the main clock MCL.

During the half-period dedicated to writing the management buffer memory 10, the following operations are effected:

RR(i)=RR(i−1)

if the next first word w0 of a segment stored in the sub-memory BM(0) is to be addressed to the transfer module 12 in order to be processed, then the first portion address stored at the head of the queue of the FIFO input memory 11 is communicated to the first register RR(0). If the head of the queue is empty, then a value specifying that there is no associated packet is communicated to the first register RR(0).

Moreover, during the half-period dedicated to reading the management buffer memory 10, the following operations are effected:

each address stored in a register RR(i) is used to read (extract from) the sub-memory BM(i) associated with the word w(i) (portion) that it contains;

the extracted portions w(i) are then sent to n first outputs of the handling module 14, which directs them to one of its second outputs 16 as a function of its status (one of n different states);

in parallel with this transfer of words w(i), the complementary data (FSA(n) and PL(i)) is communicated to the handling module 14 and then to the selected routing unit 15.

FIGS. 8 and 9 show example of modes of reading and directing portions (words w(r)) of a segment. In this example, the handler uses three outputs and all the portions of the same segment are directed to the right second output, at a rate of one portion in each clock period. At time t+0, w0i is read and directed to the second output i. At time t+1, w1i is read and directed to the second output i and w0j is read and directed to the second output j. At time t+2, w2i is read and directed to the second output i, w1j is read and directed to the second output j, and w0k is read and directed to the second output k. w2i is read in the sub-memory BM(2) and the handler 14 directs it to i and w1j is read in the sub-memory BM(1) and the handler 14 directs it to j, and so on.

The handling module 14 preferably has the same number of inputs as second outputs 16.

The number of routing units 15 is chosen as a function of the bit rate of the data to be routed. It can therefore be equal to the number of second outputs 16 of the handling module 14.

If the number of routing units 15 is less than the number n of second outputs, it is necessary to ensure that the segment to be analyzed, portion by portion, is not sent to a second output 16 that is not associated with the selected routing unit at that time. This condition is satisfied because a first segment address is sent to the first register RR(0) by the FIFO input memory 11 only if the handling module 14 is in a state authorizing the transfer to an available routing unit 15 of the word w(0)designated by RR(0) in BM(0). In the same manner, if the head of the queue of the FIFO input memory 11 is empty (i.e. if there is no packet to be routed), the word w0 designated by RR(0) in BM(0) is sent to the handling module 14 with a bit signifying that the segment is empty.

Accordingly, at most n segments can be read in parallel in the management buffer memory 10 of the management module 9 and transferred in parallel to be analyzed, also in parallel, by the routing units 15, via the second outputs 16 of the handling module 14.

To analyze the ordered portions of each segment sent via one of the second outputs 16 of the handling module 14, each routing unit 15 includes a rewritable memory 17 in which a routing table is stored.

Each routing table is preferably of the “trie table” type, as described in the paper by V. Srinivasan and G. Varghese “Fast address lookups using controlled prefix expansion”, Transactions on Computer Systems 17, 1 (Feb.), 1999, 1-40.

Unlike a standard routing table, a trie table does not contain all possible addresses and combinations of addresses. The primary data is therefore stored in rows in the form of words of first and second types representative of prefixes needed to route secondary data. A word of the first type is an “intermediate” word in the sense that it designates another word in the routing table. A word of the second type is a “final” word in the sense that it actually designates primary routing data (tertiary data such as the list of output ports 7 to which the second data is to be sent, new primary routing data (also known as an label(s)) to be associated with the corresponding secondary data to be routed to each designated output port 7, possibly with complementary information such as the quality of service).

If the device of the invention uses trie tables, each routing unit 15 includes an intermediate module 18 having an output coupled to the rewritable memory 17 (storing the trie table) and first and second inputs respectively fed by one of the second outputs of the handling module 14 and by the output of the rewritable memory 17.

The analysis of the portions (words) received from the handling module 14 preferably still begins with the first row R(0) of the routing table. In each period of the main clock MCL, the portion to be analyzed designates an address of the current row R(j) of the routing table (for the first portion of a segment, this is initially the first row R(0)). If the word read (extracted) at the designated address is of the first (intermediate word) type, it is communicated to the intermediate module 18. The value of this word designates the address at which the next word is to be read, during the next clock period. For as long at the read (extracted) word is of the first type, the search loop is iterated. On the other hand, if the read (extracted )word is of the second (final word) type, it is sent to an output stage 19 of the transfer module 12 with the complementary data FSA(n) and PL(i), and where applicable with the quality of service, as shown in FIG. 6.

Thus addresses of varying length can be analyzed.

FIG. 10 shows an example of a trie table. In this example, the table is initialized to the following addresses A: 21.35.1C.43/32, B: C1.35/16, C: C1.35.BA/24, D: 18.2D/16. Each portion has a length of four bits.

In this example, if a packet is received having a destination address equal to 18.2D.29.13 (hexadecimal), the first four bits of this address (1) designate a word from row 0 (L0). This yields L0(1)=9. The second portion (here equal to 8) is then used to address row 9 (designated by the value equal to 9 obtained). This yields L9(8)=10. The third portion (here equal to 2) is then used to address row 10 (designated by the value equal to 10 obtained). This yields L10(2)=11. Finally, the fourth portion (here equal to D) is used to address row 11 (designated by the value equal to 11 obtained). This yields L11(D)=final word, which terminates the analysis.

The output stage 19 of the transfer module 12 contains at least the same number of output buffer memories 20 as there are output ports 7 of the output sub-stage 6 of the data transport stage 2. The output memories 20 are preferably of the FIFO type. The output stage 19 preferably also includes a multiplexer 21 fed by the outputs of the routing units 15(j) and feeding the various FIFO output memories 20 with the new primary data, the tertiary data addressed to the output ports 7 respectively associated with them, the storage address FSA(s) in the buffer memory 5 of the secondary data to be routed, and the associated total number PL of segments.

If the routing tables also deliver complementary information, such as the quality of service (QoS), each output port 7 can instead be associated with a group of FIFO output memories 20. Each group then comprises a FIFO output memory associated with each quality of service offered.

The multiplexer 21 is adapted to send the data delivered by one of the routing units 15(j) to the FIFO output memory 20 associated with the output port 7 during each period of the main clock MCL. Thus the various routing units 15(j) are considered one after the other by the multiplexer 21.

The l FIFO output memories 20 are scanned cyclically. Because a cycle includes l clock periods, a FIFO memory 20 is read in each period of the main clock MCL. During the period i (modulo l), if no packet is on the point of being sent to the output port i (7), the associated FIFO output memory i (20) is read and delivers its content (address FSA(s), associated number of segments PL, and labels), so that in the next clock period the associated secondary data can be sent to the output port i (7) after adding new primary and tertiary data.

The data transport stage 2 and the routing stage 8 are described above by way of illustrative example only and lend themselves to many variations and adaptations. In particular they can be implemented by separate circuits coupled to each other or by a single circuit, possibly integrated onto the same electronic circuit card. Also, these stages consist primarily of electronic circuits, but can also include software modules, in particular for managing their respective and/or conjoint operation.

The invention also provides a method of routing secondary data associated with primary routing data and a storage address FSA(s), in which method tertiary data designating at least one output port 7 and new primary routing data is determined from the primary data and from data stored in at least one routing table, after which the primary and tertiary data so determined is delivered so that at least some of the new primary data is combined with the secondary data to be routed stored at the storage address FSA(s) and then sent to each output port 7 designated by the tertiary data,

The above method can be implemented using the devices described hereinabove. Because the main and optional functions and sub-functions provided by the steps of the method are substantially identical to those provided by the various means constituting the devices, only the steps using the main functions of the method of the invention are summarized hereinafter.

The method is characterized in that its determination phase consists of, firstly, storing in n sub-memories BM(r), at selected addresses, the portions of each segment resulting from subdivison of the data received and to be routed, secondly, storing at selected locations the selected storage addresses of the first segments successively received and then, as a function of a selected criterion, extracting from the sub-memories BM(r), in parallel, the portions stored at the storage addresses of the first segments contained in some of the selected locations so as to deliver the segment portions simultaneously and in parallel, and, thirdly, directing the portions belonging to different segments to one or more routing tables (as required)so as to determine the primary and tertiary data to be associated with the secondary data to be routed from data stored in the routing tables and a portion by portion analysis of the various segments.

The routing data is preferably processed after it has been divided into segments of equal length, for example in a preliminary step.

Moreover, it is advantageous to store the storage addresses of n first segments successively received in n substantially identical parallel registers. Similarly, up to n segments can be processed in parallel provided that the same number of routing tables is provided as there are sub-memories BM(r).

According to another feature of the method, each routing table is a “trie table”. In this case, during the determination phase, the words stored at the address that is designated by the received segment portion are extracted from the routing table, after which that word is delivered so that it feeds the routing table again or the output ports (coupled to the multiplexer 21), according to whether the extracted word is of the first type or the second type, and each time of a word of the first type is delivered, there is extracted from the table another word stored at the address designated by the word delivered, and this continues until a word of the second type is obtained.

Thanks to the invention, the routing device is transparent to the type of routing protocol used. It is sufficient to configure the routing tables for operation in accordance with the selected protocol (for example IPV4 or IPV6).

Furthermore, the invention allows adaptation to any type of bit rate by an appropriate choice of the number of parallel routing units and preserves the sequential character of the data packets belonging to the same stream.

Also, the device of the invention can be integrated into switch-routers with a distributed or centralized architecture. In the present context the expression “centralized architecture” refers to an architecture in which the main functions of a router and a switch are centralized (or shared), which functions are not inherently linked to a line interface, for example buffering, switching, routing, traffic monitoring and quality of service.

The invention also enables routing in broadcast mode or in multicast mode, provided that the maximum number of branches of the multipoint broadcast tree is equal to the number of ports of the device.

Furthermore, the invention allows any type of protocol to be used at the line interfaces, and any number of line interfaces, including at OC192c type bit rates and above.

The invention is not limited to the embodiments of devices and methods described above by way of example only, but encompasses all variants that the person skilled in the art might envisage within the scope of the following claims.

1. A data routing device comprising i) a management module (9) adapted to receive primary routing data and a storage address (FSA(s)) of secondary data associated with said primary data and ii) a transfer module (12) adapted to determine from said data and from data stored in at least one routing table tertiary data designating at least one output port (7) of a data transport stage (2) and new primary routing data and to deliver the primary and tertiary data so determined to said transport stage (2) so that at least some of the said primary data is combined with said secondary data stored at said storage address (FSA(s)) and then sent to each output port (7) designated by said tertiary data,
which device is characterized in that said management module (9) includes a buffer memory (10) divided into n sub-memories each adapted to store at a selected address a portion of each segment resulting from decomposition of data packets received and to be routed, including a first segment, and to deliver one of the portions that they store simultaneously on demand at n first parallel outputs,
and in that the transfer module (12) is adapted i) to receive from the management module (9) the selected storage addresses of the first segments of the packets to be routed, ii) to deliver some of the storage addresses to the management module as a function of a selected criterion in order to receive in return at the first parallel outputs the segment portions stored at the storage addresses, and iii) to direct the portions belonging to different segments to at least one routing table so as to determine said primary and tertiary data associated with the secondary data to be routed from data stored in said routing tables and a portion by portion analysis of the various segments.

2. A device according to claim 1, characterized in that said transfer module (8) includes at least two routing tables to enable parallel analysis of different segments.

3. A device according to either claim 1 or claim 2, characterized in that said management module (9) is adapted to receive data in the form of segments of equal length.

4. A device according to any one of claims 1 to 3, characterized in that said management module (9) and said transfer module (12) constitute an L3F routing stage (8).

5. A device according to any one of claims 1 to 4, characterized in that the transfer module (12) includes an input stage (13) provided with i) n registers (RR) adapted to store the storage addresses of n first segments, ii) an input buffer memory (11) adapted to receive said selected addresses of said first segments from the management module (9) to feed said registers (RR), and iii) a handling unit (14) having i) n inputs respectively fed with n segment portions by the n first parallel outputs and ii) at least one second output (16) adapted to deliver said directed portions belonging to different segments.

6. A device according to claim 5, characterized in that the handling unit (14) has n inputs and n second outputs.

7. A device according to any one of claims 2 to 5 in combination with claim 6, characterized in that said transfer module (12) includes from 1 to n routing units (15) fed with different segment portions by said second outputs (16) and each including a rewritable memory (17) storing one of the routing tables and adapted to determine in parallel said primary and tertiary data associated with the secondary data to be routed.

8. A device according to any one of claims 1 to 7, characterized in that each routing table stores primary data defining words representative of routing prefixes in the form of rows and each segment portion received is used to address one of said words of a row.

9. A device according to claim 8, characterized in that each routing table stores primary data representative of words of first and second types.

10. A device according to any one of claims 1 to 9, characterized in that said transfer module (12) includes an output stage (19) with the same number of output buffer memories (20) as there are output ports (7) of the transport stage (2) and adapted to receive said tertiary data, said new primary data, and said storage address (FSA(s)) of the routing units (15).

11. A device according to any one of claims 1 to 9, characterized in that said transfer module (12) includes an output stage (19) provided with the same number of output buffer memory groups (20) as there are output ports (7) of the transport stage (2), each group being adapted to receive said tertiary data, said new primary data, and said storage address (FSA(s)) of the routing units (15).

12. A device according to claim 11, characterized in that the output buffer memories (20) of a group are associated with different qualities of service.

13. A device according to any one of claims 10 to 12, characterized in that said output stage (19) includes a multiplexer (21) fed by the routing units (15) and feeding said output buffer memories (20).

14. A device according to claim 9 in combination with any one of claims 10 to 13, characterized in that each routing unit (15) i) includes an intermediate module (18) including an output coupled to the rewritable memory (17) and first and second inputs respectively fed by one of the second outputs of the input stage (13) and by the output of said rewritable memory (17) and ii) is adapted to extract from the routing table the word stored at the address designated by the received portion and then to deliver said word to the output of said rewritable memory so that it feeds the second input of the intermediate module (18) or said output stage (19), according to whether said word extracted is of the first or of the second type, and in that said intermediate module (18) is adapted, on receiving data representative of a word of the first type, to extract from the routing table the word stored at the address designated by said word of the first type and then to deliver said word to the output of said rewritable memory (17) so that it feeds the second input of the intermediate module (18) or said output stage (19), according to whether said extracted word is of the first type or of the second type.

15. A device according to any one of claims 1 to 14, characterized in that at least some of said buffer memories (11, 20) are FIFO memories.

16. A device according to any one of claims 1 to 15, characterized in that it includes said data transport stage (2).

17. A data packet handling device, characterized in that it includes a data routing device according to any preceding claim.

18. A method of routing secondary data associated with primary routing data and a storage address (FSA(s)), in which method i) tertiary data designating at least one output port (7) and new primary routing data is determined from said primary data and from data stored in at least one routing table, after which ii) said primary and tertiary data so determined is delivered so that at least some of said new primary data is combined with said secondary data stored at said storage address (FSA(s)) and then sent to each output port (7) designated by said tertiary data,
which method is characterized in that said tertiary data designating at least one output port (7) and new primary routing data is determined by i) storing in n sub-memories, at selected addresses, n portions of each segment resulting from subdivison of the data received and to be routed, including first segments, ii) storing at selected locations the selected storage addresses of the first segments and then, as a function of a selected criterion, extracting from said sub-memories, in parallel, the portions stored at said storage addresses contained in some of the selected locations so as to deliver said segment portions simultaneously and in parallel, and iii) directing the portions belonging to different segments to at least one routing table so as to determine said primary and tertiary data to be associated with the secondary data to be routed from data stored in said routing tables and a portion by portion analysis of the various segments.

19. A method according to claim 18, characterized in that the data is received in the form of segments of equal length.

20. A method according to claim 18 or claim 19, characterized in that the routing is L3F routing.

21. A method according to any one of claims 18 to 20, characterized in that said storage addresses of the first segments are stored in n registers.

22. A method according to any one of claims 18 to 21, characterized in that the number of routing tables is the same as the number of sub-memories.

23. A method according to any one of claims 18 to 22, characterized in that each routing table stores primary data defining words representative of routing prefixes in the form of rows and each received segment portion is used to address one of said words of a row.

24. A method according to claim 23, characterized in that each routing table stores primary data representative of words of first and second types.

25. A method according to claim 24, characterized in that during said determination the word stored at the address designated by the received segment portion is extracted from the routing table and is then delivered so that it feeds said routing table again or said output ports (7), according to whether the extracted word is of the first type or of the second type, and each time that a word of the first type is delivered another word stored at the address designated by said word delivered is extracted from said table, and so on until a word of the second type is obtained.

26. Use of the device and the method according to any preceding claim with routing standards selected from a group including the Internet Protocol (IP) and connectionless protocols.
